(19) United States
(12) Patent Application Publication
(10) Pub. No.: US 2004/0199889 A1
(43) Pub. Date: Oct. 7, 2004

(54) Modeling integrated circuits

(75) Inventors: Richard William Earnshaw, Cambridge (GB); John Philip Biggs, Cambridge (GB)

Correspondence Address: NIXON & VANDERHYE, PC, 1100 N GLEBE ROAD, 8TH FLOOR, ARLINGTON, VA, 22201-4714, US

(73) Assignee: ARM LIMITED, Cambridge (GB)

(21) Appl. No.: 10/751,108

(22) Filed: Jan. 5, 2004

Related U.S. Application Data
(63) Continuation of application No. 09/328,420, filed on Jun. 9, 1999, now abandoned.

(30) Foreign Application Priority Data
Jun. 15, 1998 (GB) 9812895.2

(51) Int. Cl. G06F 17/50; G06F 9/45

(52) U.S. Cl. 716/6

(57) ABSTRACT

A system of modeling an integrated circuit is described in which a circuit component model 6 is operated upon by a delay calculator 16 using a subset of associated timing and rule data 20. The delay calculator 16 calculates signal transition delays within the circuit component model 6. The output of the delay calculator 16 is searched to identify corresponding signal transitions within the original model 4. Matching transitions are then updated with the calculated delay information augmented with the full set of associated timing and rule data 23 (with constraint data).

### BACKGROUND OF THE INVENTION

1. Field of the Invention

This invention relates to the modeling of integrated circuits. More particularly, this invention relates to modeling of integrated circuits using a circuit component model.

2. Description of the Prior Art

It is known to use circuit component models (e.g. netlist models) as part of the development of an integrated circuit. Such models allow software simulation and verification to be undertaken long before even prototype versions of the physical integrated circuit are available. This allows a highly desirable reduction in product development time to be achieved.

Whilst the desirability of providing such circuit models is great, the difficulty in producing accurate models is increasing as the complexity of the circuits being modeled increases. In addition to the difficulties introduced through the increase in complexity of the integrated circuits, a further problem is that different portions of the integrated circuit may be designed and specified using different tools and possibly by different companies. As an example, if it is desired to incorporate another company's microprocessor core within your own application specific integrated circuit (ASIC), then a model of the microprocessor core needs to be supplied by its producer as the task of creating your own model of that core to the degree of accuracy required would be too large to be worthwhile. Having been supplied with such a microprocessor core model, one can then add a model of the specific surrounding circuits within the ASIC operating in conjunction with the microprocessor core to produce a model of the full ASIC. Using the component level model of the ASIC, a delay calculating tool can then be used to examine the various signal paths through the component level model to determine the specific signal transitions and associated delays taking into account the particular implementation of the integrated circuit, e.g. the fabrication process, operating temperature, etc.

Whilst delay calculators are able to automatically analyze a circuit model and produce delay values, they are generally incapable of coping with circuits that have delay characteristics that are influenced by factors such as their current state, history, complex condition parameters etc. In such circumstances, delay calculators typically take the fail safe option of presuming the worst case scenario and calculating the longest possible delay. As an example, if a portion of the ASIC being modeled were to have a de-bug mode in which its operation was very slow, then this would be assumed to be the standard level of the delays concerned and the model results produced would be very different from those realized in normal operation of the real circuit and would be essentially useless. This problem is compounded by less than full component level information being available for every part of the ASIC being modeled. For commercial reasons, the provider of a particular portion of an ASIC may not release a full component level definition of that portion but may instead release an accurate “black box” simulation. This lack of detailed information makes it practically impossible for a third party to correct the delay results in the appropriate way and even the producer of the portion of the circuit themselves is faced with a highly time consuming and arduous task.

### SUMMARY OF THE INVENTION

Viewed from one aspect the present invention provides a method of modeling an integrated circuit, said method comprising the steps of:

(i) generating a circuit component model including signal transitions with a set of associated delays and rules for a given implementation of said integrated circuit;

(ii) calculating signal delays for signal transitions within said circuit component model using a delay calculator and a subset of said set of associated delays and rules; and

(iii) searching said circuit component model to identify signal transitions corresponding to signal transitions with associated signal delays as calculated by said delay calculator; and

(iv) modifying said circuit component model for identified matching signal transitions with said delays calculated by said delay calculator and said set of associated delays and rules.

The present invention recognizes the above problem and addresses the problem by using a delay calculator with a subset of the timing and rule data to determine delay values for a particular implementation and then mapping this data back on to the component model by searching through that model for matching signal transitions and then modifying the model to reflect the calculated delay for that transition at which time the full set of time and rule data may be used to augment the model. Using a searching technique in the component model also allows a strongly advantageous degree of flexibility in the precise format and syntax that is used between the delay calculator and the model as differences can be overcome in the remapping process.

It may be that the original component model is less complete than the circuit component model which has had circuit components added to it after synthesis. For example, this would be the case when an ASIC was produced by adding specific circuits around a core circuit provided by another party and for which the original component model was also provided. In order to deal with this situation, preferred embodiments of the invention are such that if said searching does not identify a matching signal relationship within said circuit component model for a signal transition and delay calculated by said delay calculator, then said signal transition and delay is passed directly to said circuit component model.

As previously mentioned, the invention is particularly suited to circumstances in which full details of a macrocell within the integrated circuit are not available and the circuit component model is provided other than by details of individual circuit components.

The complexity problems associated with modeling integrated circuits, and particularly the dependence of circuit delays upon past history and state, are particularly acute, and so the present invention is particularly useful, in embodiments in which the integrated circuit includes a microprocessor core.

Measures that can be taken to improve the accuracy of the remapping between the calculated delays and the signal relationship model are strongly advantageous. Accordingly, in preferred embodiments of the invention:

1. if said circuit component model includes a plurality of a signal transitions that match a signal transition and delay calculated by said delay calculator, then said signal transition and delay calculated by said delay calculator is used to modify all of said plurality of signal transitions within said circuit component model;

2. if said signal transitions and delays calculated by said delay calculator include a plurality of signal transitions and delays that match a signal transition within said circuit component model, then that signal transition and delay calculated by said delay calculator that most specifically matches said signal transition within said circuit component model is used to modify said signal transition within said circuit component model; and

3. if signal transitions and delays calculated by said delay calculator include a signal transition and delay that is more specifically defined than any signal transition within said circuit component model, then the most specifically matching signal transition within said circuit component model is modified with said signal transition and delay.

In order to assist in the verification of the automated remapping that the invention uses preferred embodiments further comprise the step of generated an audit log representing the steps taken.

The audit log is particularly useful for recording the assumptions made when the result of the delay calculator is more specifically defined than any of the signal relationships within the signal relationship model.

As previously suggested, the invention is particularly suited for embodiments in which said set of associated delays and rules within said circuit component model includes associated condition parameters and said signal transitions and delays calculated by said delay calculator do not include condition parameters.

In such circumstances considerable improvements in efficiency and accuracy within the models produced can be achieved in embodiments in which different condition parameters of a signal transition within said circuit component model have different delays associated with them and said delay calculator calculates a delay for only one condition parameter and modified delay values for all of said condition parameters are inferred from said calculated delay using relative differences between said delays within said circuit component model.

The manner in which signal transitions are specified may vary considerably, but in preferred embodiments said associated set of delays and rules may include edge direction parameters.

The present invention is particularly useful when the delay calculator outputs results as a standard delay format file and this file format is commonly used by many organizations wishing to model integrated circuits.

In an analogous way in preferred embodiments the circuit component model is a netlist model with associated timing and rule data. Simulation software capable of interacting with such a model is relatively widespread.

Viewed from another aspect the present invention provides Apparatus for modeling an integrated circuit, said apparatus comprising:

(i) a memory storing a circuit component model including signal transitions with a set of associated delays and rules for a given implementation of said integrated circuit;

(ii) a delay calculator for calculating signal delays for signal transitions within said circuit component model using a subset of said set of associated delays and rules; and

(iii) search logic for searching said circuit component model to identify signal transitions corresponding to signal transitions with associated signal delays as calculated by said delay calculator; and

(iv) modifying logic for modifying said circuit component model for identified matching signal transitions with said delays calculated by said delay calculator and said set of associated delays and rules.

The above, and other objects, features and advantages of this invention will be apparent from the following detailed description of illustrative embodiments which is to be read in connection with the accompanying drawings.

### BRIEF DESCRIPTION OF THEE DRAWINGS

FIG. 1 schematically illustrates a design flow and modeling process;

FIG. 2 schematically illustrates the process of FIG. 1 modified in accordance with an example of the present invention;

FIGS. 3 and 4 together form a flow diagram presenting the remapping of the results produced by a delay calculator into a higher level model;

FIG. 5 illustrates a general purpose computer system for performing the processes illustrated with FIGS. 1 to 4; and

FIG. 6 illustrates a signal delay that is dependent upon internal state.

### DESCRIPTION OF THE PREFERRED EMBODIMENTS

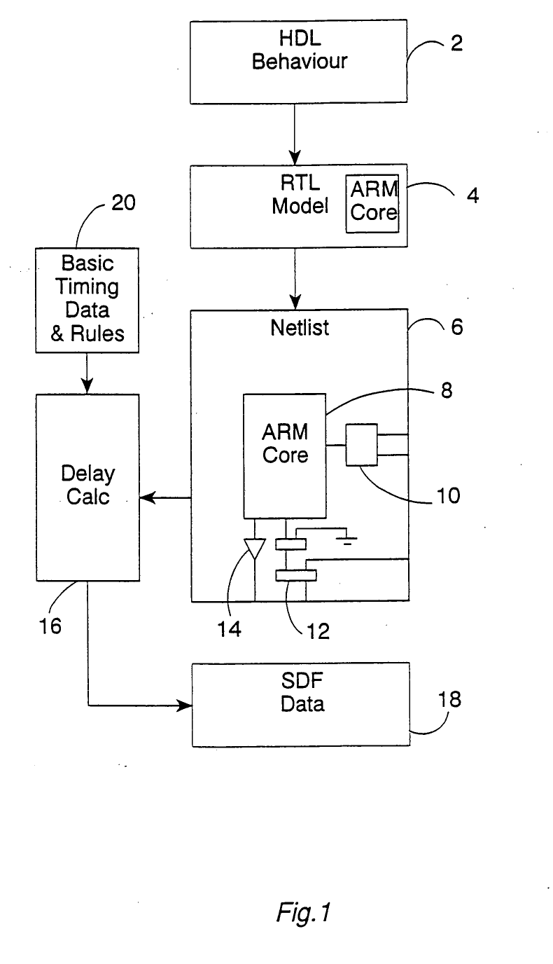

In FIG. 1 the integrated circuit producer first of all develops a model of the behavior of the integrated circuit in a high level development language, which may include an ARM core. This is illustrated by step 2.

Once the architecture and behavior have been established in step 2, a register transfer language model of the integrated circuit including the microprocessor is developed at step 4 in which signal relationships are defined involving inputs, outputs and internal signals.

The register transfer language model including an “black box” ARM core model will then be synthesized and hand amended into an efficient component level model (/specification) of the integrated circuit (e.g. a netlist). The component level definition of the ARM core (microprocessor) is a very valuable and a highly sensitive piece of property. Accordingly, rather than release a component level definition it is preferred to produce a “black box” model of the component level circuit that is able to interact with other elements within a larger component model 6 and yet does not include a complete element by element description of the microprocessor. This further model 8 can then be used by third parties to simulate ASICs in which various circuits 10, 12, 14 are attached to the microprocessor. Once this circuit component model 6 of the ASIC has been produced a delay calculator 16 may be used to calculate signal transition delays for signal paths through the ASIC taking into account the particular implementation, peripheral circuitry 10, 12, 14, operating temperature and the like. The results produced by the delay calculator 16 are output in the form of a standard delay format file 18.

The model of the microprocessor core 8 is highly complex and has associated with it a great deal of timing and rule data that takes account of factors such as signal delays depending upon the previous state of the microprocessor, the mode of operation, etc. The delay calculator 16 cannot cope with this complexity and so operates using only a basic subset of the timing and rule data.

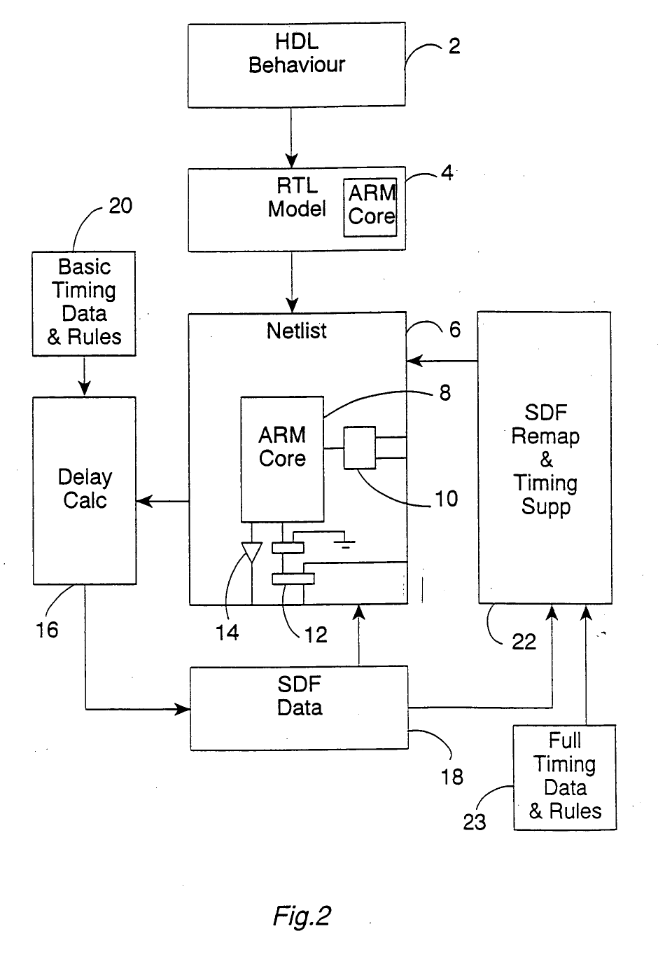

FIG. 2 illustrates a modification of the process of FIG. 1 in which the standard delay format file 18 is analyzed and remapped to produce a remapped SDF file 25. This remapping takes place at step 22. The delay calculator 16 is unable to cope with the many different possibilities in the behavior of the microprocessor core 8 and so typically makes worst-case assumptions. The remapping step 22 seeks to remap the delay results generated back to the netlist model 6 using the full set of timing and rule data 23 that is sufficient to allow many of the incorrect worst-case assumptions to be modified so as to produce a more accurate result. The full set of timing and rule data 23 can also include constraint data that provides instructions for how the remapping should be performed.

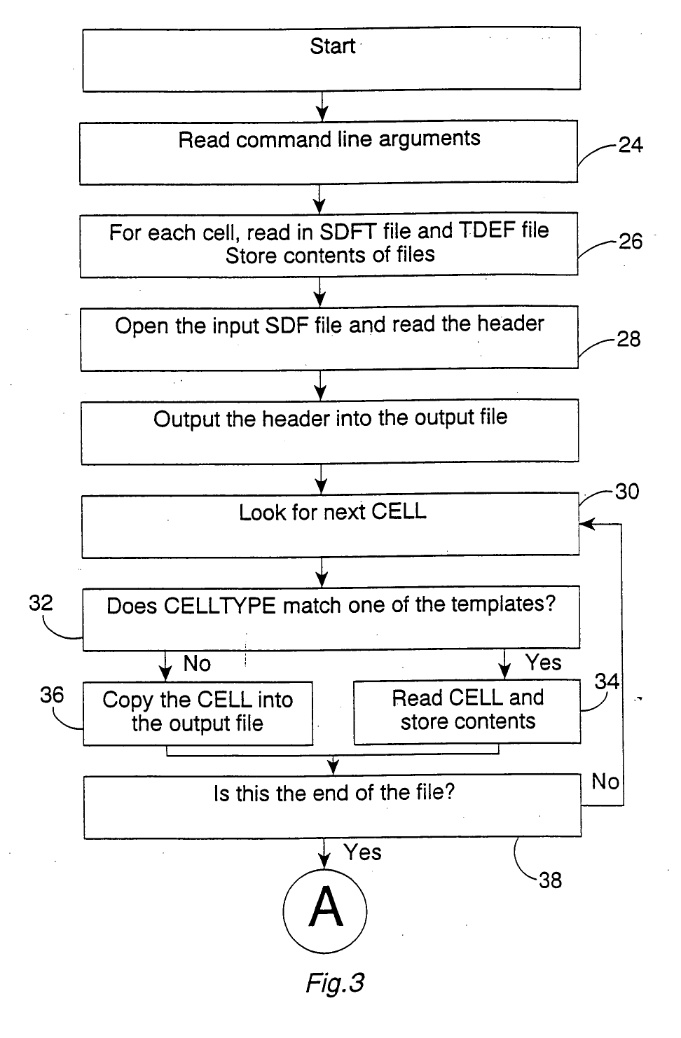

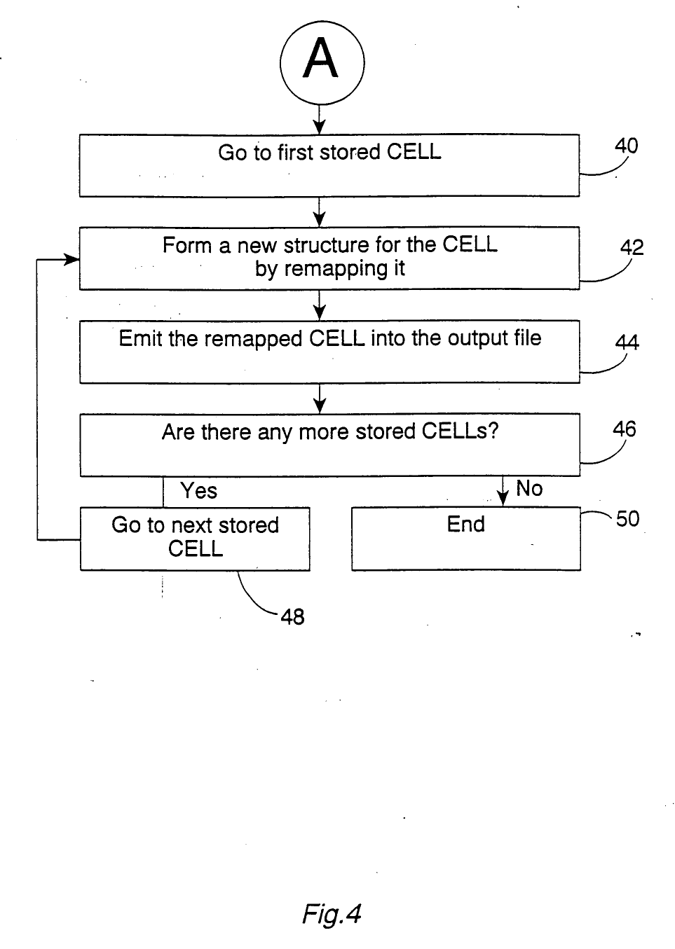

FIGS. 3 and 4 are a flow diagram illustrating the operation of the remapping process. At step 24 the process is initiated including reading arguments that specify conditions such as the input and output file names, file types, audit log options etc.

At step 26, the original component model 6 (standard delay format target SDFT) is stored to memory including reading the timing and rule files (TDEF) for each cell within the component model 6.

At step 28 the standard delay format file produced by the delay calculator 16 is opened and the header from that file written to the output file. The output file is produced from the original SDF file, the template data and the timing data and is written in the form of SDF.

At steps 30, 32, 34, 36 and 38 the process executes a loop in which the cells within the SDF file produced by the delay calculator 16 are examined in turn and matched against cells within the files from the original component model (templates stored at step 26. If the cell exists in the template then this template definition will be modified with the delay information calculated by the delay calculator 16 and used instead of the cell within the output file. If the original component model stored at step 26 does not include a matching cell, then the cell from the output of the delay calculator 16 is placed into the new model. This process continues until all of the cells in the output of the delay calculator 16 have either been matched with pre-existing cells within the original component model or have been written into the new model. At steps 40, 42, 44, 46 and 48 the different cells identified in the previous loop are examined one at a time and updated to take account of the fuller information available in the full set of timing and rule data 23, e.g. different relative timings depending upon condition parameters, edge directions, etc. The constraint data giving remapping instructions for specific delay calculator and model combinations can also be referenced to assist.

When the process has been completed at step 50 the output is a remapped SDF file 25 with delays representing a specific implementation and additional surrounding circuitry 10, 12, 14. This new SDF file can be used together with the netlist model in software verification processes and the like.

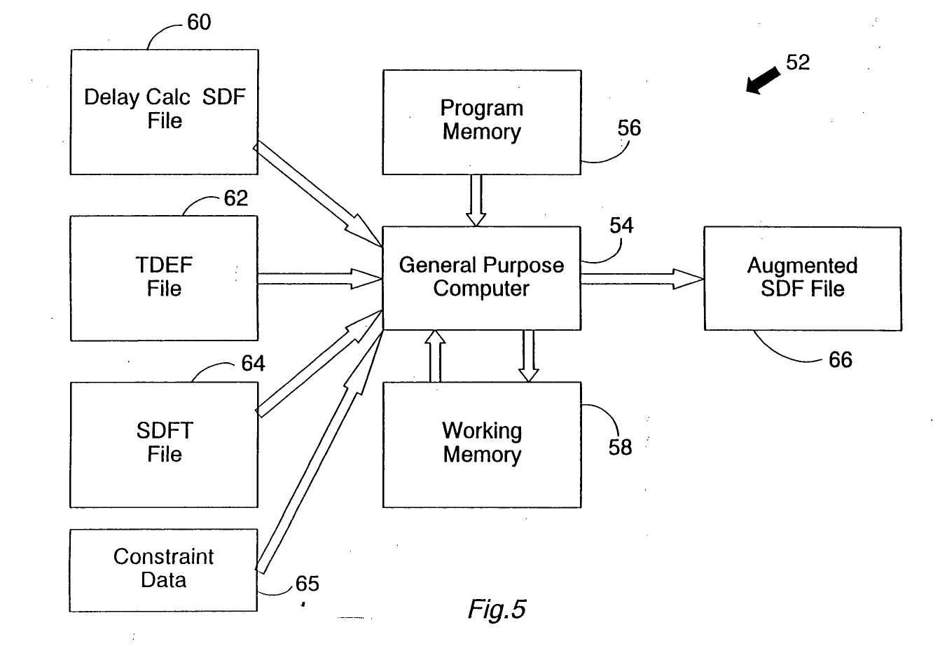

FIG. 5 illustrates a data processing system 52 that performs the various modeling and calculation processing described in relation to FIGS. 1 to 4. As will be appreciated, the modeling processes can all take place within a general purpose computer 54 operating under program control. The program can be stored in a program memory 56 as a sequence of instructions that configure the general purpose computer 54 to perform the various steps in the method of the invention or to take the role of the various processing circuits and logic elements of the invention. The general purpose computer 54 will include a working memory 58 within which the model data is stored and manipulated. The various input files 60, 62, 64, 65 may be stored on a hard disk or other medium and read by the general purpose computer 54 prior to manipulation. The revised netlist model is produced in the form of an augmented standard delay format file 66 that can also be stored on a hard disk.

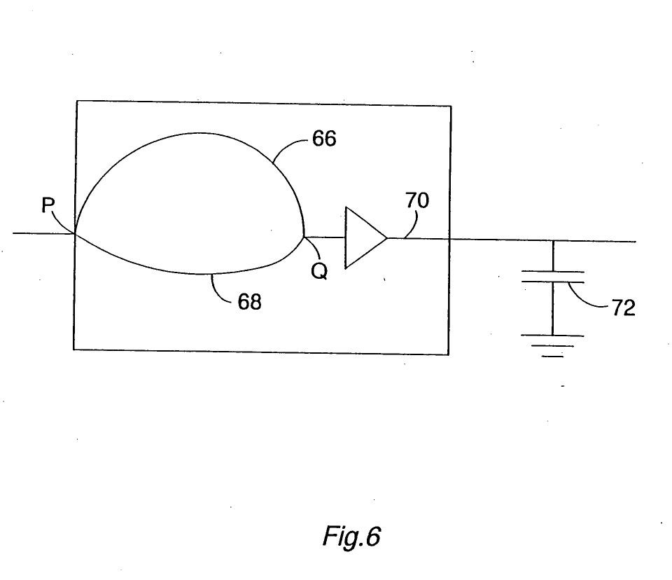

FIG. 6 shows a circuit including two possible timing paths 66, 68 between points P and Q. The delay is dependent upon the internal state of the device, states A and B. When the circuit is in state A, then the path 66,70 is used, and the delay through this path 66,70 with no load is X. When the device is in state B, then the path 68, 70 is used and the delay through this path 68, 70 with no load is Y.

The delay calculator 16 operates on a subset of the data available and calculates the delay Delay (66+70) for the worst-case path 66,70 when load 72 is present and writes the result to the SDF file 18. The remapping tool 22 takes the full original timing information and calculates the delay for path 68,70 using:

Delay (68+70)=Delay (66+70)−X+Y.

The functionality of the present invention as embodied in a software tool (SDFREMAP) for the ModelGen product produced by ARM Limited may be described as follows:

Tool Interface

sdfremap is a tool that is invoked from the command line, and takes no subsequent user input. The tool takes, as arguments, at least one SDF template file and for each template file, an optional TDEF file (timing defaults file). Other optional arguments are an input SDF file and an output SDF file. If either of these are given they are used as the input and output respectively. If no input file is given, input is taken from stdin. If no output file is given, output goes to stdout. An output filename cannot be specified unless an input filename is specified. An audit log will be created in another output file. This file can be optionally named. If no name is given, a default logfile is created.

The proposed argument format for the command line is as follows:

sdfremap [options] - cell <cellname> . . . [<sdfin> [<sdfout>]]

Items in square brackets represent optional arguments. Items in angle brackets represent parameters. The ellipsis ( . . . ) indicates that the preceding options may be repeated zero or more times.

The options field is any of the following:

-l<file> record audit log in file

-v verbose output

-q quiet output

-h show help

-V show version

-n don't use TDEF file

-d do use TDEF file

-L<dir> add dir to search path for template files

-min look for tdef files ending in _min.tdef by default.

-typ look for tdef files ending in _typ.tdef by default.

-max look for tdef files ending in _max.tdef by default.

-n and -d may be used before any instance of -cell and may be repeated any number of times. Each argument applies until the next occurrence of -n or -d. By default, TDEF files are read. The -min, -typ and -max options control the way in which TDEF files are looked for. These options are mutually exclusive. If none is specified, the tool behaves as if -typ was specified.

When the -min option is in force, the program looks for TDEF files named <cell>_min.tdef.

When the -typ option is in force, the program looks for TDEF files named <cell>_typ.tdef.

When the -max option is in force, the program looks for TDEF files named <cell>_max.tdef.

In all three cases, if the TDEF file cannot be found, the program looks for <cell>.tdef.

The name of the TDEF file chosen is recorded in the audit log.

If a TDEF file still cannot be found for a particular cell, and defaults reading is enabled, a warning should be emitted, as well as this fact recorded in the audit log, and the tool should proceed as though the -n option was in force for that cell.

The -L option applies globally, to all cells. Not just those that were specified after the -L option.

Input

The input to sdfremap consists of ModelGen created SDFT (SDF Target File) and optionally TDEF files, and a single SDF file, provided by the user, but assumed to come from a delay calculator. All files are assumed to be syntactically correct, so in-depth grammar and syntax conformance checking is not required. The tool should at least provide diagnostics if the input is incorrect, stating the line number and error type. The input SDF file must conform to the OVI version 2.1 (or 2.0) SDF specification.

Output

The primary output from the tool will be an SDF file that contains information obtained from the input SDF file, possibly extrapolated and/or augmented with information from the TDEF files, with CELL entries that pertain to any of the CELLTYPEs in the SDFT files rewritten with the structure of the appropriate SDFT files. Some manipulation of bus ranges may need to be performed, but otherwise the structure should exactly match the template. CELLTYPEs that do not correspond to any of the template files are passed to the output file unaltered.

Diagnostic messages will be written to the stderr. An audit log of the remapping process for each cell will be written into the log file.

Operation

The program will read, and store the relevant contents of any SDFT and TDEF files specified on the command line. It will then read the input SDF file, reproducing the header and any cell entries for devices other than the ones described in the SDFT files into the output SDF file. Cell types that match any of the SDFT files should be read in and stored, without being emitted as-is.

The stored information from the original SDF file and the SDFT file(s) is then used to produce CELL entries that have a structure compatible with that of the SDFT file, to the extent that it will annotate information from the original SDF file into a ModelGen simulation for that cell. Any missing information will be filled in by reference to a TDEF file, if provided. When filling in data from the TDEF file, the token representing output delay is replicated over all three firled of the remapped triple in the case of three values SDF, and used as the single value in single value SDF. The output hold time is always ignored.

The tool will log information describing the remapping steps it is taking into the audit file. The implementation should not make it difficult to support incremental delays in a later version (where a cell wouldn't be emitted until the end of the file, when we can be sure of having seen all incremental blocks).

The bulk of the remapping work is likely to involve transforming unconditional SDF entries, or entries with the conditions incorrectly specified into conditional SDF entries, of the type in the template file. Some of these transformations may be ambiguous, and any decisions taken in the face of ambiguity or extrapolations from entries with a similar, but not identical set of qualifying conditions to the required entries must be accurately recorded in the audit file. Early implementations may treat conditions very simplisticly. Later versions can try to be more intelligent about how they are treated, employing a set of matching heuristics which are to be decided.

If the template contains buses for a particular entry (separate entries for each bit), and the input contains ranges, the ranges should be exploded into bus bits. If the SDF file contains exploded buses, and the template contains ranges the buses in the output should be exploded too. If neither file contains exploded buses, the output will not be exploded either. The aim is to find the “lowest common denominator” between the template and SDF files in terms of bus bits, so that any information restricted to particular bus bits is represented as such, but with the structure required by the template. This should not cause problems for VITAL or Verilog annotators.

The tool will work on both DELAY and TIMINGCHECK entries. It need only operate on the SDF constructs that we support within those entries initially, namely:

SETUP

HOLD

SETUPHOLD

WIDTH

PERIOD

IOPATH

And possibly NOCHANGE, since we have the ability to generate it in our SDF, but never actually do (it would be expanded into SETUP and HOLD checks). Entries that we do not support should be emitted unchanged.

Templates must-be re-usable after each mapping, since there may be more than one instance of a particular cell type in the SDF file.

Thus, the operation of sdfremap is as illustrated in FIGS. 3 and 4.

Example Remappings

(1)—Simple Substitution with Missing Parameters in Template.

The input contains:

(IOPATH MCLK A[31:0] (5))

And the template contains:

(IOPATH MCLK A[31:0] (Ta) (Th) ( ))

The result is:

(IOPATH MCLK A[31:0] (5))

Rationale—even though the template doesn't provide a value for the 0-Z and 1-Z transitions, the input does (implicitly), so the output does too.

(2) Widening the Context.

If the input contains, as the only path between MCLK and Q:

(IOPATH (posedge MCLK) Q . . .

And the template contains:

(IOPATH MCLK Q

Then the posedge entry should probably be used, with a note to the effect that the scope of the input has been widened to include both MCLK edges.

(3) State Dependency.

If the input contains:

(IOPATH MCLK Q . . .

And the template contains:

(COND foo & bar (IOPATH MCLK . . .

(COND wibble (IOPATH MCLK Q . . .

The numbers from the input should apply to both template entries, because the input forms a superset of the cases represented by each template.

(4) Most Specific Match.

In the event where there are two or more entries in the input that match the same entry in the template, the more specific input entry should be chosen, e.g.

Input SDF:

i) (IOPATH MCLK Q . . .

ii) (IOPATH (negedge MCLK) Q . . .

Template:

a) (COND wibble (IOPATH (negedge MCLK) Q . . .

b) (COND foo | ˜bar (IOPATH MCLK Q . . .

Entry <ii> from the input should be applied to entry <a> in the template, because, despite both <i> and <ii> matching, the negedge in entry <ii> makes it a closer match for <a>. Entry <i> should be used to match entry <b>, because it covers all the circumstances where <b> would be applied, whereas <ii> does not.

More complex types of matching, especially where the input SDF is conditional, may also be provided.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

1. A method of modeling an integrated circuit, said method comprising the steps of:
(i) generating a circuit component model including signal transitions with a set of associated delays and rules for a given implementation of said integrated circuit;
(ii) calculating signal delays for signal transitions within said circuit component model using a delay calculator and a subset of said set of associated delays and rules; and
(iii) searching said circuit component model to identify signal transitions corresponding to signal transitions with associated signal delays as calculated by said delay calculator; and
(iv) modifying said circuit component model for identified matching signal transitions with said delays calculated by said delay calculator and said set of associated delays and rules.

2. A method as claimed in claim 1, wherein if said searching does not identify a matching signal relationship within said circuit component model for a signal transition and delay calculated by said delay calculator, then said signal transition and delay is passed directly to said circuit component model.

3. A method as claimed in claim 1, wherein said integrated circuit includes a macrocell which is modeled within said circuit component model other than by a details of individual circuit components.

4. A method as claimed in claim 3, wherein said macrocell is a microprocessor core.

5. A method as claimed in claim 1, wherein, if said circuit component model includes a plurality of a signal transitions that match a signal transition and delay calculated by said delay calculator, then said signal transition and delay calculated by said delay calculator is used to modify all of said plurality of signal transitions within said circuit component model.

6. A method as claimed in claim 1, wherein if said signal transitions and delays calculated by said delay calculator include a plurality of signal transitions and delays that match a signal transition within said circuit component model, then that signal transition and delay calculated by said delay calculator that most specifically matches said signal transition within said circuit component model is used to modify said signal transition within said circuit component model.

7. A method as claimed in claim 1, wherein if signal transitions and delays calculated by said delay calculator include a signal transition and delay that is more specifically defined than any signal transition within said circuit component model, then the most specifically matching signal transition within said circuit component model is modified with said signal transition and delay.

8. A method as claimed in claim 1, further comprising the step of generating an audit log representing the steps taken.

9. A method as claimed in claim 7, further comprising the step of generating an audit log representing the steps taken and wherein said modification of said most specifically matching signal transition within said circuit component model with said more specifically defined signal transition and delay is recorded in said audit log.

10. A method as claimed in claim 1, wherein said set of associated delays and rules within said circuit component model includes associated condition parameters and said signal transitions and delays calculated by said delay calculator do not include condition parameters.

11. A method as claimed in claim 9, wherein different condition parameters of a signal transition within said circuit component model have different delays associated with them and said delay calculator calculates a delay for only one condition parameter.

12. A method as claimed in claim 10, wherein modified delay values for all of said condition parameters are inferred from said calculated delay using relative differences between said delays within said circuit component model.

13. A method as claimed in claim 1, wherein at least one of said associated set of delays and rules includes edge direction parameters.

14. A method as claimed claim 1, wherein said delay calculator outputs results as a standard delay format file.

15. A method as claimed in claim 1, wherein said circuit component model is a netlist model with associated timing and rule data.

16. A method as claimed in claim 15, wherein said associated timing and rule data is a standard delay format file.

17. A method as claimed in claim 16, wherein said step of modifying modifies said standard delay format file.

18. A method as claimed in claim 1, wherein said step of modifying is responsive to constraint data specifying instructions for how said modification should be performed.

19. Apparatus for modeling an integrated circuit, said apparatus comprising:
(i) a memory storing a circuit component model including signal transitions with a set of associated delays and rules for a given implementation of said integrated circuit;
(ii) a delay calculator for calculating signal delays for signal transitions within said circuit component model using a subset of said set of associated delays and rules; and
(iii) search logic for searching said circuit component model to identify signal transitions corresponding to signal transitions with associated signal delays as calculated by said delay calculator; and
(iv) modifying logic for modifying said circuit component model for identified matching signal transitions with said delays calculated by said delay calculator and said set of associated delays and rules.
